(19) United States
(12) Patent Application Publication
(10) Pub. No.: US 2009/0014199 A1
(43) Pub. Date: Jan. 15, 2009

(54) Insulated non-halogenated heavy metal free vehicular cable

(76) Inventors: Raman V. Chiruvella, Decatur, GA (US); Leonard Allan Weiner, Cortland, OH (US); Eugene W. Yeager, Warren, OH (US); Daniel Thomas Quinlan, Brookfield, OH (US); Paul J. Pawlikowski, Cortland, OH (US); Edward Lee Monroe, Cortland, OH (US); Bruce D. Lawrence, Cortland, OH (US)

Correspondence Address: DELPHI TECHNOLOGIES, INC., M/C 480-410-202, PO BOX 5052, TROY, MI, 48007, US

(21) Appl. No.: 12/217,001

(22) Filed: Jul. 1, 2008

Related U.S. Application Data
(63) Continuation-in-part of application No. 11/473,648, filed on Jun. 23, 2006, now Pat. No. 7,408,116.

(51) Int. Cl. H01B 7/00

(52) U.S. Cl. 174/110 R; 174/110 F

(57) ABSTRACT

Described is an insulated non-halogenated, heavy metal free vehicular cable comprising an inner core of a copper based metal wire having a cross sectional area of between about 0.05 mm² and about 0.13 mm², and an outer insulation, covering the length of the inner core, comprised of a thermoplastic polyphenylene ether composition that has no halogen or heavy metal added thereto.

This application is a continuation-in-part of U.S. patent application Ser. No. 11/473,648 filed on Jun. 23, 2006, and a continuation-in-part of U.S. patent application entitled “INSULATED NON-HALOGENATED HEAVY METAL FREE VEHICULAR CABLE” filed on Jun. 24, 2008, which is a continuation application of U.S. patent application Ser. No. 11/473,648 filed on Jun. 23, 2006, under attorney docket number DP-315096 (CONT) with express mail label number EM 152405065 US. The disclosures of both these earlier filed applications are hereby incorporated by reference in their entirety.

### TECHNICAL FIELD

The present invention is concerned with a vehicular cable that utilizes insulation that is non-halogenated and heavy metal free. In particular, the invention pertains to an automotive wire harness of a non-halogenated composition.

### BACKGROUND OF THE INVENTION

Environmental regulations dictate that the material selection in the vehicular industry needs to be halogen free and heavy metal free compositions especially for the vehicular cables. Typically, polyvinyl chloride (PVC) is utilized because of its combination of competitive raw materials costs and desirable properties. These properties include processability, toughness, chemical resistance and ability to withstand temperatures typical for many applications in automotive environments.

Unfortunately, the chlorine content of PVC limits its disposal at the end of the life of the vehicle. Also there are concerns about effects on health and the environment by PVC by-products and PVC plasticizer. Accordingly, therefore, a replacement for PVC has long been sought with an intent to find competitive cost efficient replacements. In addition, performance must be taken into account including high temperature endurance, toughness processability and also reduction in weight.

It is therefore desirable to have a material that is a vehicular cable insulation, is cost effective and still achieves desirable characteristics such as lack of halogens and heavy metals, appropriate conductivity, temperature resistance, scrape abrasion resistance, resistance to heat aging, resistance to automotive fluids and resistance to flame and in particular to be capable of meeting the standard ISO (International Organization for Standardization) 6722 and offers all these properties with a reduction in weight.

### SUMMARY OF THE INVENTION

Described is an insulated non-halogenated, heavy metal free vehicular cable comprising an inner core of a copper based metal wire having a cross sectional area of between about 0.05 mm² and about 0.13 mm², and an outer insulation, covering the length of the inner core, comprised of a thermoplastic polyphenylene ether composition that has no halogen or heavy metal added thereto.

### BRIEF DESCRIPTION OF THE DRAWINGS

Further objects and advantages of the invention will be apparent from the following description and appended claims, reference being made to the accompanying drawings forming a part of the specification, wherein like reference characters designate corresponding parts in several views.

FIG. 1 is a perspective view of the vehicular cable of the present invention;

FIG. 2 is a cross-section of FIG. 1 taken along lines 2-2;

FIG. 3 is a die used to manufacture an embodiment of the insulated vehicular cable of the present invention; and

FIG. 4 is a cross-section of FIG. 3 taken along lines 4-4.

### DETAILED DESCRIPTION OF THE INVENTION

With increasing electronic content in automobiles there is an ever growing need for miniaturizing the size of the cables that provide resistance to physical abuse and provide resistance to flame and automotive fluids among other requirements to be met for the automotive industry such as ISO 6722. It has been found to be particularly desirable to utilize an insulated non-halogenated, heavy metal free vehicular cable containing a copper based metal wire that has a diameter of between about 0.05 mm² and about 0.13 mm² and an outer insulation covering the length of the inner core comprised of a thermoplastic polyphenylene ether composition which has no halogen or heavy metal added thereto.

### DEFINITIONS

By “non-halogenated” is meant that the polymeric material that is utilized has no halogen material that is added to the composition, as a desirable component of the composition.

By “heavy metal free” is meant that no heavy metal such as mercury, hexavalent chrome, cadmium, lead and the like are added to the metal core, as a desirable component of the metal composition.

By “copper based metal” is meant that the metal wire is comprised of greater than 50% by weight of the metal being copper, or copper alloyed with other metal components as is well known in the industry yet maintaining suitable electrical conductivity. Well known copper based alloys may be used such as HPC-80EF, trademark Phelps Dodge.

By “polyphenylene ether” is meant a thermoplastic polymeric material which is commercially available and generally are polymers of monohydroxy aromatic materials. Other readily available materials are 2,6-xylenol or a 2,3,6-trimethylphenyl and polymers thereof. Polyphenylene ether (PPE) is also known as polyphenylene oxide (PPO) and is described in the literature. See U.S. Pat. Nos. 3,306,874, 3,306,875; 3,257,357; and 3,257,358, which are herein incorporated by reference.

Frequently polyphenylene ether materials are a blend of other thermoplastic or cross-linked ethylenically unsaturated materials such as polyolefinic materials, styrene or styrene butadiene or polyacrylamide and the like. These materials are commercially available such as Noryl, Luranyl, Ultranyl or Vestoblend, trademarks of GE. Some materials that may be utilized include Noryl WCV072, WCV072L-111, and the like of GE.

It has been found that the ultra thin cable and cable wall that is utilized in the present case even at a small cross section of 0.1 mm² give a very satisfactory result in abrasion cycling tests such as that called for in ISO-6722.

The cross sectional area of the copper wire can range from about 0.05 to about 3 square millimeters, such as 30 AWG to 12 AWG, alternatively 0.05 to 1.5 square millimeters.

The insulated cable of the present invention is prepared utilizing normal well known commercially available equipment where the desired polyphenylene ether polymer is fed to an extrusion machine where the molten viscous polymer is passed through a die, as shown in FIGS. 3-4, so that the insulating PPE is wrapped around the linear portion of the metal conductor wire. The processing temperatures that may be utilized can vary as is well known in the industry. However, it has been found desirable to heat the resin material obtained from the supplier as follows. The thermoplastic polyphenylene ether material is dried at about 180° F. for at least 2 hours and is then passed through the first stage of an extrusion machine. The feed temperature is approximately 115° F. The compression temperature and the metering temperature in the barrels of the extruder can vary. A compression temperature may be from about 475° F. to 490° F. The metering temperature is approximately 500° F. to 540° F. The cross head or the die temperature is approximately 540° F. to 560° F. After the wire is extruded with the insulated material thereon, it passes through a cooling water bath and mist which is maintained at room temperature and then is packed as a cable in a barrel for subsequent handling.

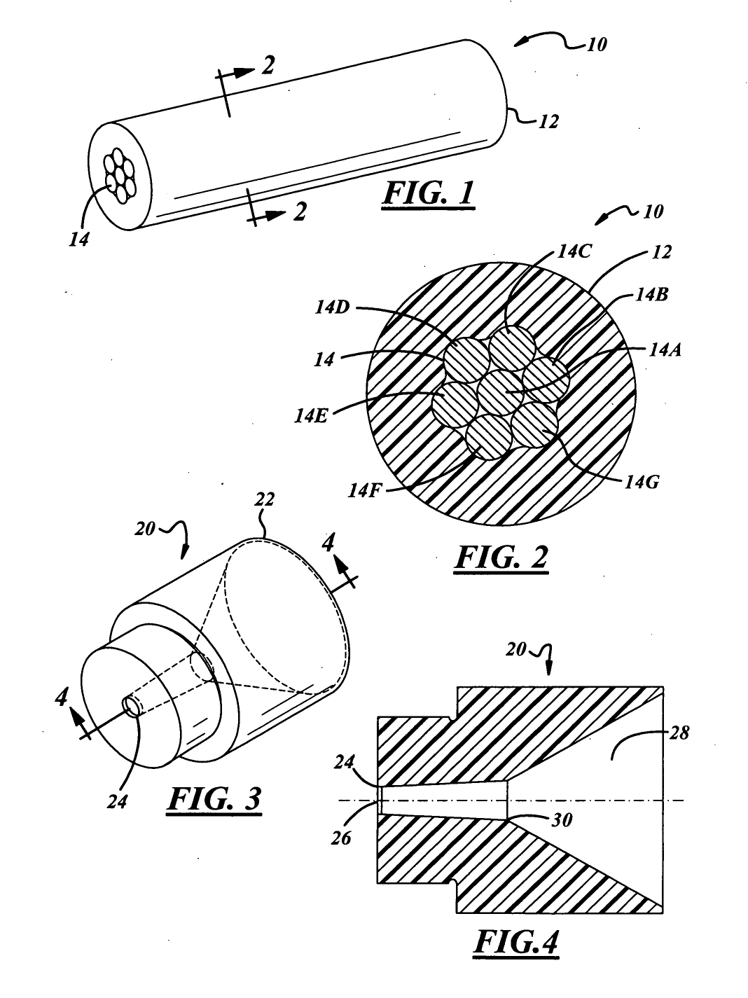

Turning now to a description of the drawings. FIG. 1 is the insulated vehicular cable 10 of the present invention having an insulated member 12 of PPE extruded or wrapped around the copper base metal core 14. An embodiment is shown in FIGS. 1 and 2 wherein the inner copper core is comprised of several wires 14 A-G with a central wire 14 A. The central wire 14A is surrounded by the other wires 14 B-G. There can be 7, 19 or 37 strands in metal core 14, in some instances they are compressed and in the other they are bunched.

During the extrusion process of the insulated vehicular cable 10, the copper based core is fed through the middle of die 20 entering the back end 22 of the die and exiting from the die at 24. The die has a central portion 26 through which the copper based wire 14 passes. The hot viscous PPE will be passed into the space 28 at the entrance end 22 of the die 20 and proceeds to envelop the copper wire. The die begins to narrow at 30 as PPE is extruded with the copper based wire passing from 30 through exit 24 of the die. At the exit 24 of the die, the insulated vehicular cable 10 of the present invention is obtained. The cooling process as described above and the packaging of the cable follows thereafter.

The diameter of the insulated vehicular cable 10 of the present invention can vary substantially. A cable diameter that has been found useful is between 0.85 and 0.92 mm in case of 0.13 mm² copper based core. Other dimensions of an insulated vehicular cable would be one that has approximately 0.13 square millimeters of wire as its cross sectional area but which is used to form the embodiment shown in FIG. 1 namely a central wire with six surrounding wires. In that case, the conductor diameter may be approximately 0.465 millimeters with a cable diameter 10 of approximately 0.88 millimeters with the minimum insulated wall thickness of 0.198 millimeters.

As indicated above a wide variety of commercially available extruding equipment may be utilized such as an extruder identified as BMD60-24D or a Nokia Maillefer, and the like.

The die utilized in the present invention may be manufactured from a wide variety of commercially available materials such as D2 hardened tool steel.

Following the procedures outlined in ISO-6722, scrape abrasion resistance using 7(N) load and 0.45 millimeter needle was used on three sets of cables, the first being compressed halogen free cable ISO ultra thin wall cable referred as CHFUS, the second ISO thin wall cable referred as HFSS and the third ISO thick wall cable referred as HF. The test results are identified in tables 1 and 2 below.

TABLE 1
CHFUS

| | 0.13* | 0.22* | 0.35* | 0.50* | 0.75* | 1.00* | 1.25* |
|---|---|---|---|---|---|---|---|
| Normal Force(N) | 4.0 | 4.0 | 5.0 | 5.0 | 6.0 | 6.0 | 6.0 |
| Minimum cycles required | 100 | 100 | 100 | 150 | 150 | 180 | 180 |
| at the normal force | | | | | | | |
| Result | 166 | 550 | 338 | 376 | 536 | 526 | 1315 |
| 7 N Load | 151 | 338 | 244 | 1150 | 836 | 960 | 2181 |
| | 125 | 379 | 223 | 458 | 1078 | 1171 | 610 |
| | 174 | 397 | 287 | 560 | 722 | 984 | 2673 |
| Minimum cycles attained by | 125 | 338 | 223 | 376 | 536 | 526 | 610 |
| the cable at 7 Newton load | | | | | | | |
| Pass/Fail | ∘ | ∘ | ∘ | ∘ | ∘ | ∘ | ∘ |

*Wire Size (square mm)

TABLE 2
HFSS

| | | | | | | | HF |
|---|---|---|---|---|---|---|---|
| | 0.35* | 0.50* | 0.75* | 1.00* | 1.25* | 2.00* | 3.00* |
| Normal Force(N) | 5.0 | 5.0 | 6.0 | 6.0 | 6.0 | 7.0 | 7.0 |
| Minimum cycles required | 100 | 150 | 150 | 180 | 180 | 750 | 750 |
| at the normal force | | | | | | | |
| Result | 443 | 4067 | 7193 | 6043 | 10434 | 12586 | *>5000 |
| 7 N Load | 2396 | 893 | 9636 | 3896 | 5158 | 10835 | |
| | 830 | 4271 | 4512 | 7771 | 3559 | 11203 | |
| | 1031 | 2586 | 6198 | 8776 | 16333 | 12308 | |
| Minimum cycles attained | 443 | 893 | 4512 | 3896 | 3559 | 10835 | *>5000 |
| by the | | | | | | | |
| cable at 7 Newton load | | | | | | | |
| Pass/Fail | ∘ | ∘ | ∘ | ∘ | ∘ | ∘ | ∘ |

*Wire Size (square mm)

Following the procedures outlined in ISO-6722 a number of tests were so performed where the cross sectional area of the copper wire varied as well as the diameter of insulated polyphyenelyene ether varied as is shown in tables 3-4.

TABLE 3

| | | | | | Cable Type and Size | | | | |
|---|---|---|---|---|---|---|---|---|---|
| | | | | | | CHFUS | | | |
| | | | | | | Size | | | |
| Test | | Item | | Unit | Wire Thickness Area (square mm) | 0.13 | 0.22 | 0.35 | 0.50 |
| ISO6722 | Certification | Dimensions | Thickness | (mm) | | 0.179 | 0.274 | 0.190 | 0.211 |
| | | | of Ins. (min) | | | | | | |
| | | | Cable Outer Dia. | (mm) | | 0.872 | 1.027 | 1.127 | 1.279 |
| | | Electrical | Resistance | (mΩ/m) | Sec 6.1 Must be smaller than | 157.100 | 78.600 | 49.600 | 34.600 |
| | | | | | requirement (Measured result) | | | | |
| | | | | | See Table 4 | | | | |
| | | | | (mΩ/m) | Requirement | 169.900 | 84.400 | 54.400 | 37.100 |
| | | | Ins. Resistance | | Sec. 6.2 Breakdown shall not occur | Pass | Pass | Pass | Pass |
| | | | in water | | | | | | |
| | | | Spark test | | Sec. 6.3 No breakdown shall | Pass | Pass | Pass | Pass |
| | | | | | occur when the earthed cable | | | | |
| | | | | | is drawn through the test electrode | | | | |
| | | Mechanical | Pressure test | | Sec. 7.1 Breakdown shall not | Pass | Pass | Pass | Pass |
| | | | at high temp. | | occur during the withstand | | | | |
| | | | | | voltage test | | | | |
| | | Low-temp | Winding under | | Sec. 8.1 After winding, no | Pass | Pass | Pass | Pass |
| | | | low temp | | conductor shall be visible. | | | | |
| | | | | | During the withstand voltage test, | | | | |
| | | | | | breakdown shall not occur. | | | | |
| | | Abrasion | Scrape | (N) | Sec. 9.3 Load requirement | 4 | 4 | 5 | 5 |
| | | | | (times) | Scrape requirement | 100 | 100 | 100 | 150 |
| | | | | (times) | Min. scrape result | 1309 | 3052 | 951 | 1636 |
| | | Heat aging | Short high temp | | Sec. 10.1 After winding, no | Pass | Pass | Pass | Pass |
| | | | | | conductor shall be visible. | | | | |
| | | | | | During the withstand voltage test, | | | | |
| | | | | | breakdown shall not occur. | | | | |
| | | | Long high temp | | Sec. 10.2 After winding, no | Pass | Pass | Pass | Pass |
| | | | 85 deg C. | | conductor shall be visible. | | | | |
| | | | | | During the withstand voltage test, | | | | |
| | | | | | breakdown shall not occur. | | | | |
| | | | Shrinkage by | (mm) | Sec. 10.4 The maximum shrinkage | Pass | Pass | Pass | Pass |
| | | | high temp | | shall not exceed 2 mm at | | | | |
| | | | | | either end | | | | |
| | | Resistance | Gasoline | (%) | Sec. 11.1 The maximum outside | Pass | Pass | Pass | Pass |
| | | to chemical | | | cable diameter change shall | 5.15 | 5.40 | 0.09 | 2.83 |
| | | | Diesel | (%) | meet the requirement shown in | Pass | Pass | Pass | Pass |
| | | | | | Table 13. After winding, no | 4.56 | 4.72 | 8.63 | −0.58 |
| | | | Engine Oil | (%) | conductor shall be visible. | Pass | Pass | Pass | Pass |
| | | | | | During the withstand voltage test, | 5.75 | 2.44 | 2.70 | −6.91 |
| | | | | | breakdown shall not occur. | | | | |

| | | | | | Cable Type and Size | | | | |
|---|---|---|---|---|---|---|---|---|---|
| | | | | | | CHFUS | | | |
| | | | | | | Size | | | |
| Test | | Item | | Unit | Wire Thickness Area (square mm) | 0.75 | 1.00 | 1.25 | 1.50 |
| ISO6722 | Certification | Dimensions | Thickness | (mm) | | 0.194 | 0.196 | 0.210 | 0.223 |
| | | | of Ins. (min) | | | | | | |
| | | | Cable Outer Dia. | (mm) | | 1.391 | 1.590 | 1.794 | 1.849 |
| | | Electrical | Resistance | (mΩ/m) | Sec 6.1 Must be smaller than | 24.300 | 17.200 | 14.100 | 12.000 |
| | | | | | requirement (Measured result) | | | | |
| | | | | | See Table 4 | | | | |
| | | | | (mΩ/m) | Requirement | 24.700 | 18.500 | 14.900 | 12.700 |
| | | | Ins. Resistance | | Sec. 6.2 Breakdown shall not occur | Pass | Pass | Pass | Pass |
| | | | in water | | | | | | |
| | | | Spark test | | Sec. 6.3 No breakdown shall | Pass | Pass | Pass | Pass |
| | | | | | occur when the earthed cable | | | | |
| | | | | | is drawn through the test electrode | | | | |
| | | Mechanical | Pressure test | | Sec. 7.1 Breakdown shall not | Pass | Pass | Pass | Pass |
| | | | at high temp. | | occur during the withstand | | | | |
| | | | | | voltage test | | | | |
| | | Low-temp | Winding under | | Sec. 8.1 After winding, no | Pass | Pass | Pass | Pass |
| | | | low temp | | conductor shall be visible. | | | | |
| | | | | | During the withstand voltage test, | | | | |
| | | | | | breakdown shall not occur. | | | | |
| | | Abrasion | Scrape | (N) | Sec. 9.3 Load requirement | 6 | 6 | 6 | 6 |
| | | | | (times) | Scrape requirement | 150 | 180 | 180 | 200 |
| | | | | (times) | Min. scrape result | 441 | 844 | 883 | 1058 |
| | | Heat aging | Short high temp | | Sec. 10.1 After winding, no | Pass | Pass | Pass | Pass |
| | | | | | conductor shall be visible. | | | | |
| | | | | | During the withstand voltage test, | | | | |
| | | | | | breakdown shall not occur. | | | | |
| | | | Long high temp | | Sec. 10.2 After winding, no | Pass | Pass | Pass | Pass |
| | | | 85 deg C. | | conductor shall be visible. | | | | |
| | | | | | During the withstand voltage test, | | | | |
| | | | | | breakdown shall not occur. | | | | |
| | | | Shrinkage by | (mm) | Sec. 10.4 The maximum shrinkage | Pass | Pass | Pass | Pass |
| | | | high temp | | shall not exceed 2 mm at | | | | |
| | | | | | either end | | | | |
| | | Resistance | Gasoline | (%) | Sec. 11.1 The maximum outside | Pass | Pass | Pass | Pass |
| | | to chemical | | | cable diameter change shall | −6.39 | 0.06 | 0.00 | 0.32 |
| | | | Diesel | (%) | meet the requirement shown in | Pass | pass | Pass | Pass |
| | | | | | Table 13. After winding, no | −0.40 | 6.20 | 3.55 | 1.88 |
| | | | Engine Oil | (%) | conductor shall be visible. | Pass | Pass | Pass | Pass |
| | | | | | During the withstand voltage test, | −5.66 | −4.84 | 0.83 | 0.70 |
| | | | | | breakdown shall not occur. | | | | |

TABLE 3A

| | | | | | Cable Type and Size | | | | |
|---|---|---|---|---|---|---|---|---|---|
| | | | | | | CHFUS | | | |
| | | | | | | Size | | | |
| Test | | Item | | Unit | Wire Thickness Area (square mm) | 0.13 | 0.22 | 0.35 | 0.50 |
| | | Flame | Flamability | (Sec) | Sec. 12 Any combustion flame of | 0.0 | 0.0 | 0.0 | 0.0 |
| | | | at 45 degree | | insulating material shall extinguish | | | | |
| | | | angle | | within 70 s, and a minimum of 50 mm | | | | |
| | | | | | of insulation at the top of the test sample | | | | |
| | | | | | shall remain unburned | | | | |
| | If required | Electrical | Insulation | Ohm mm | Sec. 6.4 Greater than 10° Ohm mm | Pass | Pass | Pass | Pass |
| | | | volume | | | 1.6E+15 | 1.0E+16 | 1.70E+16 | 2.50E+21 |
| | | | resistivity | | | | | | |
| | | Mechanical | Strip force | (N) | Sec. 7.2 Greater than specified by | 28.8 Pass | 31.6 Pass | 41 Pass | 69.7 Pass |
| | | | | | customer Requirement (Min) | 2 | 2 | 5 | 5 |
| | | Low-temp | Impact | | Sec. 8.2 After impact, no conductor shall | Not | Not | Not | Not |
| | | | | | be visible. During the withstand voltage | required | required | required | required |
| | | | | | test, breakdown shall not occur. | | | | |
| | | Heat aging | Thermal | | Sec. 10.3 After winding, no conductor | Pass | Pass | Pass | Pass |
| | | | overload | | shall be visible. During the withstand | | | | |
| | | | | | voltage, breakdown shall not occur | | | | |
| | | Resistance | Ethanol | | Sec. 11.1 The maximum outside cable | Pass | Pass | Pass | Pass |
| | | to chemical | | (%) | diameter change shall meet the | 4.01 | 4.42 | 2.70 | −6.98 |
| | | | Power | | requirement shown in Table 13. After | Pass | Pass | Pass | Pass |
| | | | steering | (%) | winding, no conductor shall be visible. | 4.00 | 6.39 | 3.68 | 5.76 |
| | | | fluid | | During the withstand voltage test, | | | | |
| | | | Automatic | | breakdown shall not occur. | Pass | Pass | Pass | Pass |
| | | | transmission | (%) | | 4.07 | 5.52 | 4.31 | 6.05 |
| | | | fluid | | | | | | |
| | | | Engine | | | Pass | Pass | Pass | Pass |
| | | | coolant | (%) | | 3.09 | 0.29 | 0.99 | 1.65 |
| | | | Battery | | | Pass | Pass | Pass | Pass |
| | | | | (%) | | −0.11 | 1.48 | 1.08 | 2.12 |
| | | | Ozone | | Sec. 11.3 The visual examination of the | Pass | | | |
| | | | | | insulation shall not reveal any cra♯ | | | | |
| | | | Hot water | (Ω · mm) | Sec. 11.4 The insulation volume | Pass | | | |
| | | | | | resistivity shall not be less than 10° Ohm | | | | |
| | | | | | mm. A visual examination of the | | | | |
| | | | | | insulation | | | | |
| | | | Temp. and | | Sec. 11.5 After winding, no conductor | Pass | Pass | Pass | Pass |
| | | | humidity | | shall be visible. During the withstand | | | | |
| | | | cycling | | voltage test, breakdown shall not occur | | | | |
| | | | | | Cable Type and Size | | | | |
| | | | | | | CHFUS | | | |
| | | | | | | Size | | | |
| Test | | Item | | Unit | Wire Thickness Area (square mm) | 0.75 | 1.00 | 1.25 | 1.50 |
| | | Flame | Flamability | (Sec) | Sec. 12 Any combustion flame of | 0.0 | 0.0 | 4.0 | 4.0 |
| | | | at 45 degree | | insulating material shall extinguish | | | | |
| | | | angle | | within 70 s, and a minimum of 50 mm | | | | |
| | | | | | of insulation at the top of the test sample | | | | |
| | | | | | shall remain unburned | | | | |
| | If required | Electrical | Insulation | Ohm mm | Sec. 6.4 Greater than 10° Ohm mm | Pass | Pass | Pass | Pass |
| | | | volume | | | 8.60E+17 | 3.50E+21 | 7.30E+17 | 9.10E+19 |
| | | | resistivity | | | | | | |
| | | Mechanical | Strip force | (N) | Sec. 7.2 Greater than specified by | 52.5 Pass | 75.7 Pass | 70.1 Pass | 63.8 Pass |
| | | | | | customer Requirement (Min) | 5 | 5 | 5 | 5 |
| | | Low-temp | Impact | | Sec. 8.2 After impact, no conductor shall | Not | Not | Not | Not |
| | | | | | be visible. During the withstand voltage | required | required | required | required |
| | | | | | test, breakdown shall not occur. | | | | |
| | | Heat aging | Thermal | | Sec. 10.3 After winding, no conductor | Pass | Pass | Pass | Pass |
| | | | overload | | shall be visible. During the withstand | | | | |
| | | | | | voltage, breakdown shall not occur | | | | |
| | | Resistance | Ethanol | | Sec. 11.1 The maximum outside cable | Pass | Pass | Pass | Pass |
| | | to chemical | | (%) | diameter change shall meet the | −6.06 | −5.26 | 1.33 | 1.61 |
| | | | Power | | requirement shown in Table 13. After | Pass | Pass | Pass | Pass |
| | | | steering | (%) | winding, no conductor shall be visible. | −4.73 | −3.48 | 1.33 | 3.71 |
| | | | fluid | | During the withstand voltage test, | | | | |
| | | | Automatic | | breakdown shall not occur. | Pass | Pass | Pass | Pass |
| | | | transmission | (%) | | −2.46 | −3.96 | 2.11 | 1.51 |
| | | | fluid | | | | | | |
| | | | Engine | | | Pass | Pass | Pass | Pass |
| | | | coolant | (%) | | −0.20 | 0.06 | 0.44 | −0.32 |
| | | | Battery | | | Pass | Pass | Pass | Pass |
| | | | | (%) | | −1.00 | 0.24 | 0.00 | −0.32 |

| Ozone | | Sec. 11.3 The visual examination of the | Pass | | | |
|---|---|---|---|---|---|---|
| | | insulation shall not reveal any cra♯ | | | | |
| Hot water | (Ω · mm) | Sec. 11.4 The insulation volume | Pass | | | |
| | | resistivity shall not be less than 10° Ohm | | | | |
| | | mm. A visual examination of the | | | | |
| | | insulation | | | | |
| Temp. and | | Sec. 11.5 After winding, no conductor | Pass | Pass | Pass | Pass |
| humidity | | shall be visible. During the withstand | | | | |
| cycling | | voltage test, breakdown shall not occur | | | | |

TABLE 4

| | | | | | Cable Type and Size | | | | |
|---|---|---|---|---|---|---|---|---|---|
| | | | | | | HFSS | | | |
| | | | | | | Size | | | |
| Test | | Item | | Unit | Wire Thickness Area (square mm) | 0.35 | 0.50 | 0.75 | 1.00 |
| ISO6722 | Certifi- | Dimensions | Thickness | (mm) | | 0.258 | 0.231 | 0.252 | 0.322 |
| | cation | | of Ins. | | | | | | |
| | | | (min) | | | | | | |
| | | | Cable | (mm) | | 1.289 | 1.481 | 1.773 | 1.943 |
| | | | Outer Dia. | | | | | | |
| | | Electrical | Resistance | (mΩ/m) | Sec 6.1 Must be smaller than requirement | 46.200 | 33.100 | 23.200 | 16.800 |
| | | | | | (Measured result) See Table 4 | | | | |
| | | | | (mΩ/m) | Requirement | 54.400 | 37.100 | 24.700 | 18.500 |
| | | | Ins. | | Sec. 6.2 Breakdown shall not occur | Pass | Pass | Pass | Pass |
| | | | Resistance | | | | | | |
| | | | in water | | | | | | |
| | | | Spark test | | Sec. 6.3 No breakdown shall occur when | Pass | Pass | Pass | Pass |
| | | | | | the earthed cable is drawn through the | | | | |
| | | | | | test electrode | | | | |
| | | Mechanical | Pressure | | Sec. 7.1 Breakdown shall not occur during | Pass | Pass | Pass | Pass |
| | | | test at high | | the withstand voltage test | | | | |
| | | | temp. | | | | | | |
| | | Low-temp | Winding | | Sec. 8.1 After winding, no conductor | Pass | Pass | Pass | Pass |
| | | | under low | | shall be visible. During the withstand | | | | |
| | | | temp | | voltage test, breakdown shall not occur. | | | | |
| | | Abrasion | Scrape | (N) | Sec. 9.3 Load requirement | 5 | 5 | 6 | 6 |
| | | | | (times) | Scrape requirement | 100 | 150 | 150 | 180 |
| | | | | (times) | Min. scrape result | 1688 | 2141 | >5000 | >5000 |
| | | Heat aging | Short | | Sec. 10.1 After winding, no conductor | Pass | Pass | Pass | Pass |
| | | | high temp | | shall be visible. During the withstand | | | | |
| | | | | | voltage test, breakdown shall not occur. | | | | |
| | | | Long high | | Sec. 10.2 After winding, no conductor | Pass | Pass | Pass | Pass |
| | | | temp 85 | | shall be visible. During the withstand | | | | |
| | | | deg C. | | voltage test, breakdown shall not occur. | | | | |
| | | | Shrinkage | (mm) | Sec. 10.4 The maximum shrinkage | Pass | Pass | Pass | Pass |
| | | | by high | | shall not exceed 2 mm at either end | | | | |
| | | | temp | | | | | | |
| | | Resistance | Gasoline | (%) | Sec. 11.1 The maximum outside cable | Pass | Pass | Pass | Pass |
| | | to chemical | | | diameter change shall meet the | −4.79 | −4.54 | −3.57 | 2.07 |
| | | | Diesel | (%) | requirement shown in Table 13. After | Pass | Pass | Pass | Pass |
| | | | | | winding, no conductor shall be visible. | −3.50 | −2.71 | −1.65 | 3.16 |
| | | | Engine Oil | (%) | During the withstand voltage test, | Pass | Pass | Pass | Pass |
| | | | | | breakdown shall not occur. | −6.36 | −5.74 | 1.17 | 2.19 |

Cable Type and Size

| | | | | | | | | PPO |
|---|---|---|---|---|---|---|---|---|
| | | | | | | HFSS | | HF |
| | | | | | | Size | | Size |
| Test | | Item | | Unit | Wire Thickness Area (square mm) | 1.25 | 2.00 | 3.00 |
| ISO6722 | Certifi- | Dimensions | Thickness | (mm) | | 0.320 | 0.348 | 0.653 |
| | cation | | of Ins. | | | | | |
| | | | (min) | | | | | |
| | | | Cable | (mm) | | 2.088 | 2.551 | 3.598 |
| | | | Outer Dia. | | | | | |
| | | Electrical | Resistance | (mΩ/m) | Sec 6.1 Must be smaller than requirement | 13.900 | 8.840 | 5.76 |
| | | | | | (Measured result) See Table 4 | | | |
| | | | | (mΩ/m) | Requirement | 14.900 | 9.420 | 6.150 |
| | | | Ins. | | Sec. 6.2 Breakdown shall not occur | Pass | Pass | Pass |
| | | | Resistance | | | | | |
| | | | in water | | | | | |
| | | | Spark test | | Sec. 6.3 No breakdown shall occur when | Pass | Pass | Pass |
| | | | | | the earthed cable is drawn through the | | | |
| | | | | | test electrode | | | |
| | | Mechanical | Pressure | | Sec. 7.1 Breakdown shall not occur during | Pass | Pass | Pass |
| | | | test at high | | the withstand voltage test | | | |
| | | | temp. | | | | | |
| | | Low-temp | Winding | | Sec. 8.1 After winding, no conductor | Pass | Pass | Pass |
| | | | under low | | shall be visible. During the withstand | | | |
| | | | temp | | voltage test, breakdown shall not occur. | | | |
| | | Abrasion | Scrape | (N) | Sec. 9.3 Load requirement | 6 | 7 | 7 |
| | | | | (times) | Scrape requirement | 180 | 750 | 750 |
| | | | | (times) | Min. scrape result | >5000 | 10835 | >5000 |
| | | Heat aging | Short | | Sec. 10.1 After winding, no conductor | Pass | Pass | Pass |
| | | | high temp | | shall be visible. During the withstand | | | |
| | | | | | voltage test, breakdown shall not occur. | | | |
| | | | Long high | | Sec. 10.2 After winding, no conductor | Pass | Pass | Pass |
| | | | temp 85 | | shall be visible. During the withstand | | | |
| | | | deg C. | | voltage test, breakdown shall not occur. | | | |
| | | | Shrinkage | (mm) | Sec. 10.4 The maximum shrinkage | Pass | Pass | Pass |
| | | | by high | | shall not exceed 2 mm at either end | | | |
| | | | temp | | | | | |
| | | Resistance | Gasoline | (%) | Sec. 11.1 The maximum outside cable | Pass | Pass | Pass |
| | | to chemical | | | diameter change shall meet the | 2.23 | 6.77 | 13.4 |
| | | | Diesel | (%) | requirement shown in Table 13. After | Pass | Pass | Pass |
| | | | | | winding, no conductor shall be visible. | −2.00 | 2.20 | 1.63 |
| | | | Engine Oil | (%) | During the withstand voltage test, | Pass | Pass | Pass |
| | | | | | breakdown shall not occur. | −3.91 | 0.94 | 0.14 |

TABLE 4A

| | | | | | Cable Type and Size | | | | |
|---|---|---|---|---|---|---|---|---|---|
| | | | | | | HFSS | | | |
| | | | | | | Size | | | |
| Test | | Item | | Unit | Wire Thickness Area (square mm) | 0.35 | 0.50 | 0.75 | 1.00 |
| | | Flame | Flamability | (Sec) | Sec. 12 Any combustion flame of insulating | 0.0 | 0.0 | 4.0 | 5.0 |
| | | | at 45 degree | | material shall extinguish within 70 s, and a | | | | |
| | | | angle | | minimum of 50 mm of insulation at the top | | | | |
| | | | | | of the test sample shall remain unburned | | | | |
| | If | Electrical | Insulation | Ohm mm | Sec. 6.4 Greater than 10⁹ Ohm mm | Pass | Pass | Pass | Pass |
| | required | | volume | | | 2.90E+21 | 7.70E+17 | 8.30E+16 | 2.80E+16 |
| | | | resistivity | | | | | | |
| | | Mechanical | Strip force | (N) | Sec. 7.2 Greater than specified by customer | 63 Pass | 115.3 | 69.4 Pass | 88.0 Pass |
| | | | | | Requirement (Min) | 5 | 5 | 5 | 5 |
| | | Low-temp | Impact | | Sec. 8.2 After impact, no conductor shall | Not | Not | Pass | Pass |
| | | | | | be visible. During the withstand voltage test, | required | required | | |
| | | | | | breakdown shall not occur. | | | | |
| | | Heat aging | Thermal | | Sec. 10.3 After winding, no conductor Shall | Pass | Pass | Pass | Pass |
| | | | overload | | be visible. During the withstand voltage, | | | | |
| | | | | | breakdown shall not occur | | | | |
| | | Resistance | Ethanol | | Sec. 11.1 The maximum outside cable | Pass | Pass | Pass | Pass |
| | | to chemical | | (%) | diameter change shall meet the requirement | 5.93 | −5.36 | 1.17 | 5.97 |
| | | | Power | | shown in Table 13. After winding, no | Pass | Pass | Pass | Pass |
| | | | steering | (%) | conductor shall be visible. During the | −5.36 | −3.72 | −3.52 | 6.99 |
| | | | fluid | | withstand voltage test, breakdown shall | | | | |
| | | | Automatic | | not occur. | Pass | Pass | Pass | Pass |
| | | | transmission | (%) | | −5.65 | −4.61 | −3.09 | 6.99 |
| | | | fluid | | | | | | |
| | | | Engine | | | Pass | Pass | Pass | Pass |
| | | | coolant | (%) | | −7.22 | 0.13 | −5.54 | −1.17 |
| | | | Battery | | | Pass | Pass | Pass | Pass |
| | | | | (%) | | 0.78 | −0.19 | −0.32 | 5.00 |

| Ozone | | Sec. 11.3 The visual examination of the | Pass | | | |
|---|---|---|---|---|---|---|
| | | insulation shall not reveal any cracks | | | | |
| Hot water | (Ω · mm) | Sec. 11.4 The insulation volume resistivity | Pass | | | |
| | | shall not be less than 10⁹ Ohm mm. A | | | | |
| | | visual examination of the insulation | | | | |
| Temp. and | | Sec. 11.5 After winding, no conductor shall | Pass | Pass | Pass | Pass |
| humidity | | be visible. During the withstand voltage test, | | | | |
| cycling | | breakdown shall not occur | | | | |

| | | | Cable Type and Size | | | |
|---|---|---|---|---|---|---|
| | | | | | | PPO |
| | | | | HFSS | | HF |
| | | | | Size | | Size |
| Test | Item | Unit | Wire Thickness Area (square mm) | 1.25 | 2.00 | 3.00 |

| | | | | | | | |
|---|---|---|---|---|---|---|---|
| | Flame | Flamability | (Sec) | Sec. 12 Any combustion flame of insulating | 4.0 | 8.0 | 14 |
| | | at 45 degree | | material shall extinguish within 70 s, and a | | | |
| | | angle | | minimum of 50 mm of insulation at the top | | | |
| | | | | of the test sample shall remain unburned | | | |
| If | Electrical | Insulation | Ohm mm | Sec. 6.4 Greater than 10⁹ Ohm mm | Pass | Pass | Pass |
| required | | volume | | | 3.20E+16 | 9.70E+16 | 3.40E+21 |
| | | resistivity | | | | | |
| | Mechanical | Strip force | (N) | Sec. 7.2 Greater than specified by customer | 112 Pass | 113.3 Pass | 230 |
| | | | | Requirement (Min) | 5 | 10 | 15 |
| | Low-temp | Impact | | Sec. 8.2 After impact, no conductor shall | Pass | Pass | Pass |
| | | | | be visible. During the withstand voltage test, | | | |
| | | | | breakdown shall not occur. | | | |
| | Heat aging | Thermal | | Sec. 10.3 After winding, no conductor Shall | Pass | Pass | Pass |
| | | overload | | be visible. During the withstand voltage, | | | |
| | | | | breakdown shall not occur | | | |
| | Resistance | Ethanol | | Sec. 11.1 The maximum outside cable | Pass | Pass | Pass |
| | to chemical | | (%) | diameter change shall meet the requirement | −3.82 | 1.45 | 1.3 |
| | | Power | | shown in Table 13. After winding, no | Pass | Pass | Pass |
| | | steering | (%) | conductor shall be visible. During the | −2.64 | 2.08 | 0.36 |
| | | fluid | | withstand voltage test, breakdown shall | | | |
| | | Automatic | | not occur. | Pass | Pass | Pass |
| | | transmission | (%) | | −2.55 | 1.92 | 0.58 |
| | | fluid | | | | | |
| | | Engine | | | Pass | Pass | Pass |
| | | coolant | (%) | | 0.00 | 0.74 | 0.64 |
| | | Battery | | | Pass | Pass | Pass |
| | | | (%) | | 0.38 | −0.04 | 0 |

| Ozone | | Sec. 11.3 The visual examination of the | Pass | | |
|---|---|---|---|---|---|
| | | insulation shall not reveal any cracks | | | |
| Hot water | (Ω · mm) | Sec. 11.4 The insulation volume resistivity | Pass | | |
| | | shall not be less than 10⁹ Ohm mm. A | | | |
| | | visual examination of the insulation | | | |
| Temp. and | | Sec. 11.5 After winding, no conductor shall | Pass | Pass | Pass |
| humidity | | be visible. During the withstand voltage test, | | | |
| cycling | | breakdown shall not occur | | | |

An insulated vehicular cable 10 may also have a copper based metal core 14 that has a cross-sectional area as low as about 0.05 mm².

For example, in one embodiment, and referring back to FIG. 1, the copper based metal core 14 may comprise seven copper wires 14A-G. These wires 14A-G may be sized and bunched together to provide the core 14 with a cross-sectional area of about 0.05 mm² (a cross-sectional area also sometimes referred as 30 AWG). It should be noted, however, that the number of copper wires that are bunched together to form the core 14 at this size can vary. Some alternative examples include forming the core 14 with 19 or 37 copper wires.

An insulation layer 12 comprising a polyphenylene ether material that is halogen and heavy metal free may cover the length of the copper based metal core 14. A suitable polyphenylene ether material for forming the insulation layer 12 is available from GE and known as Noryl WCV072. The insulation layer 12 may have a wall thickness of about 0.1 mm to about 0.2 mm.

As such, the cross-sectional area of the core 14 and the wall thickness of the insulation layer 12 can provide the insulated vehicular cable 10 of this embodiment with a relatively small diameter for use in fabricating smaller and lighter wire bundles and automobile wire harnesses without jeopardizing electrical performance. For example, the insulated vehicular cable 10 can achieve an outer diameter of about 0.56 mm if the copper based metal core has a cross-sectional area of 0.05 mm² and the insulation layer 12 is employed with a wall thickness of 0.1 mm. As another example, the insulated vehicular cable 10 can achieve an outer diameter of about 0.75 mm if the same 0.05 mm² copper based metal core is used and the thickness of the insulation layer 12 is approximately doubled to about 0.2 mm.

In another embodiment, and referring again to FIG. 1, the copper based metal core 14 may comprise seven copper wires 14A-G sized and bunched together to provide the core 14 with a cross-sectional area of about 0.08 mm² (a cross-sectional area also sometimes referred to as 28 AWG). Of course, as in the previous embodiment, the number of copper wires that form the core 14 can vary. The insulation layer 12 that covers the length of the copper based metal core 14 may also be similar to that of the previous embodiment; that is, it may comprise a polyphenylene ether material that is halogen and heavy metal free and also have a wall thickness of about 0.1 mm to about 0.2 mm. As a corollary of these dimensions the insulated vehicular cable 10 can achieve an outer diameter of about 0.57 mm if the copper based metal core has a cross-sectional area of 0.08 mm² and the insulation layer 12 is employed with a wall thickness of 0.1 mm. On the other hand, if the wall thickness of the insulation layer 12 is approximately doubled to about 0.2 mm, the insulated vehicular cable 10 can achieve an outer diameter of about 0.80 mm. The 0.08 mm² cross-sectional copper based core 14 of this embodiment can thus provide the insulated vehicular cable 10 with a relatively small outer diameter similar to that of the previous embodiment where a 0.05 mm² core was utilized—albeit slightly larger.

A variety of tests were performed on the insulated vehicle cables just described to determine if they can provide the physical, mechanical, and electrical properties desired for implementation in a motor vehicle. The cables tested had copper core cross-sectional areas of 0.05 mm² and 0.08 mm², and an insulation layer comprised of Noryl WCV072 that ranged in wall thickness from about 0.1 mm to about 0.2 mm. Also tested for comparative purposes were larger gauge insulated vehicle cables that were similarly insulated with Noryl WCV072 but at a constant wall thickness of 0.2 mm. The properties attributed to each cable tested are shown below in Table 5.

As can be seen, the cables with copper based core cross-sectional areas of 0.05 mm² and 0.08 mm² are lighter and smaller than cables that utilize larger gauge copper based cores. They also exhibit a comparably low electrical resistivity. Moreover the reductions observed in break strength, column strength, needle abrasion values, and pinch—an expected result due to the use of smaller cores and thinner insulation layers—are relatively minimal in terms of industry acceptable cable properties. These observed properties therefore seemingly render the 0.05 mm² and 0.08 mm² core size cables acceptable for motor vehicle use.

TABLE 5

| | | | | | | | | | | Column Strength | | |
|---|---|---|---|---|---|---|---|---|---|---|---|---|
| Core | | | Cable | Cable | | | | Needle | Needle | grip xx mm | | |
| Size | Core | | OD | Weight | Resist | | Pinch | 7N | 4N | behind | | |
| mm² | Material | Wall | mm | grams | mΩ/m | Break N | Kgf | Cycles | Cycles | 20 | 12 | 7 |
| 0.35 | Cu | 0.2 | 1.18 | 3.6 | 49.6 | 123.9 | 3.8 | 379 | | 18.7 | 43.3 | 50.4 |
| 0.22 | | | 1.02 | 2.5 | 79.6 | 81.2 | 3.3 | 223 | 2697 | 8.3 | 24.2 | 42.1 |
| 0.13 | Cu Alloy | | 0.91 | 1.6 | 164 | 126.7 | 2.7 | 154 | 1654 | 4.5 | 14.3 | 28.3 |
| 0.08 | Cu Alloy | 0.2 | 0.8 | 1.1 | 295.3 | 82.1 | 2.34 | 169 | 1623 | 3.5 | 7.5 | 15.7 |
| 0.08 | Cu Alloy | 0.1 | 0.57 | 0.9 | 295.7 | 72.5 | 1.08 | 1 | 20 | 1.9 | 4.5 | 7.7 |
| 0.05 | Cu Alloy | 0.2 | 0.75 | 0.9 | 369.7 | 68 | 1.92 | 91 | 1045 | 2.2 | 5.6 | 9.9 |
| 0.05 | | 0.1 | 0.56 | 0.7 | 369.4 | 61.4 | 1.02 | 3 | 33 | 1.5 | 3.3 | 6.1 |

While the forms of the invention herein disclosed constitute presently preferred embodiments, many others are possible. It is not intended herein to mention all of the possible equivalent forms or ramifications of the invention. It is understood that the terms used herein are merely descriptive rather than limiting and that various changes may be made without departing from the spirit or the scope of the invention.

We claim:

1. An insulated non-halogenated, heavy metal free vehicular cable comprising:
a copper based metal core that has a cross-sectional area of about 0.05 mm² to about 0.08 mm²;
an outer insulation that surrounds the copper based metal core and comprises a thermoplastic polyphenylene ether composition that has no halogen or heavy metal added thereto, the outer insulation having a wall thickness from about 0.1 mm to about 0.2 mm.

2. The insulated cable of claim 1 wherein the copper based metal core has a cross-sectional area of about 0.05 mm².

3. The insulated cable of claim 2 wherein the insulation layer has a wall thickness of about 0.1 mm.

4. The insulated cable of claim 2 wherein the insulation layer has a wall thickness of about 0.2 mm.

5. The insulated cable of claim 1 wherein the copper based metal core has a cross-sectional area of about 0.08 mm².

6. The insulated cable of claim 5 wherein the insulation layer has a wall thickness of about 0.1 mm.

7. The insulated cable of claim 5 wherein the insulation layer has a wall thickness of about 0.2 mm.

8. The insulated cable of claim 1 wherein the thermoplastic polyphenylene ether material comprises a polymer formed from an ethylenically unsaturated material.

9. The insulated cable of claim 8 wherein the polymer formed from an ethylenically unsaturated material comprises at least one of a polyolefinic material, a polystyrene, a polystyrene-butadiene, or a polyacrylamide.

10. The insulated cable of claim 1 wherein the thermoplastic polyphenylene ether material comprises a polymer of at least one monohydroxy aromatic material.

11. The insulated cable of claim 10 wherein the at least one monohydroxy aromatic material comprises 2,6 xylenol or 2,3,6-trimethylphenyl.

12. The insulated cable of claim 1 wherein the copper based metal core comprises seven copper wires.

13. An insulated vehicle cable comprising:
a copper based metal core having by a cross-sectional area and a length;
an insulation layer having a wall thickness and covering the length of the copper based metal core, the insulation layer being comprised of a polyphenylene ether material that is free of halogens and heavy metals; and
wherein the cross-sectional area of the copper based metal core and the wall thickness of the insulation layer provide the insulated vehicle cable with an outer diameter from about 0.56 mm to about 0.80 mm.

14. The insulated vehicle cable of claim 13 wherein the cross-sectional area of the copper based metal core is about 0.05 mm², and the wall thickness of the insulation layer is between about 0.1 mm and about 0.2 mm.

15. The insulated vehicle cable of claim 13 wherein the cross-sectional area of the copper based metal core is about 0.08 mm², and the wall thickness of the insulation layer is between about 0.1 mm and 0.2 mm.

16. The insulated vehicle cable of claim 13 wherein the thermoplastic polyphenylene ether material comprises a polymer formed from an ethylenically unsaturated material.

17. The insulated cable of claim 16 wherein the polymer formed from an ethylenically unsaturated material comprises at least one of a polyolefinic material, a polystyrene, a polystyrene-butadiene, or a polyacrylamide.

18. The insulated cable of claim 13 wherein the thermoplastic polyphenylene ether material comprises a polymer of at least one monohydroxy aromatic material.

19. The insulated cable of claim 18 wherein the at least one monohydroxy aromatic material comprises 2,6 xylenol or 2,3,6-trimethylphenyl.

20. The insulated cable of claim 13 wherein the copper based metal core comprises seven copper wires.
